(19) United States
(12) Patent Application Publication
(10) Pub. No.: US 2004/0019564 A1
(43) Pub. Date: Jan. 29, 2004

(54) System and method for payment transaction authentication

(76) Inventors: Scott Goldthwaite, Hingham, MA (US); Geoff Crellin, Richardson, TX (US); William Graylin, Woburn, MA (US)

Correspondence Address: AKC PATENTS, 215 GROVE ST., NEWTON, MA, 02466, US

(21) Appl. No.: 10/205,768

(22) Filed: Jul. 26, 2002

(51) Int. Cl. G06F 17/60

(52) U.S. Cl. 705/44

(57) ABSTRACT

An electronic payment system utilized by a customer to pay for the purchase of a good and/or a service with a payment card. The payment system includes a merchant server, an authentication server and a communication device. The merchant server is in connection with a first network and is adapted to receive a purchase order by the customer for the purchase of a good and/or a service and to create a digital purchase order. The authentication server is in connection with the first network and is adapted to receive the digital purchase order from the merchant server over the first network, format the digital purchase order into a first message and route it over a second network to the communication device. The communication device includes the identification information of the payment card, and is adapted to receive the first message from the authentication server over the second network, display the first message to the customer, request and receive authorization for payment for the purchase order from the customer, retrieve payment card identification information, request and receive payment card security information from the customer, and route the authorization result and in case of a positive authorization result the payment card identification and security information to the authentication server over the second network. The authorization result and payment card identification and security information are routed over the first network from the authentication server to the financial institution that has issued the payment card. The financial institution is asked to approve and execute the requested payment and to route the payment approval result through the authentication server to the merchant server and to the communication device.

### FIELD OF THE INVENTION

The present invention relates to a system and a method for payment transaction authentication, and more particularly to a strong authentication of a payment transaction that utilizes personal communication devices and smart cards.

### BACKGROUND OF THE INVENTION

Payment transactions have evolved from hard currency to checks and credit/debit cards. In the recent years, with the introduction of eCommerce, consumers can purchase goods and services from remote merchants via the Internet, or the telephone. Another way of purchasing goods and services from remote merchants is via mail order from a catalog. Credit cards and debit cards have been the main payment instrument for these eCommerce and mail order transactions.

Referring to FIG. 1, when a customer 102 makes a purchase from a remote merchant server 104 via an Internet web browser, the customer 102 usually types the number and expiration date of a payment card (credit or debit) into a form on a website. The merchant server 104 transfers the payment card number, expiration date, and information about the purchase including price, quantity, item number, and date of transaction to a payment server 106. The payment server 106 contacts the financial institution 112 that has issued the specific payment card and handles the payment transactions for the specific payment card. The financial institution 112 executes the transaction and sends a confirmation notice to the payment server 106. The payment server 106 routes the confirmation notice to the merchant server 104 and the merchant server 104 fulfills the customer's purchase order. The payment card information and the purchase order information are usually encrypted for security purposes. The encrypted information may be transferred via Internet or telephone connections 80, 82, and 84. When the transaction occurs via the telephone the customer 102 either dictates the card number and expiration date to a sales representative or enters them using the telephone keypad. In these non-face-to-face payment transactions via the Internet, the telephone, or mail order, the merchant server 104 has no means of verifying the presence of the payment card (i.e., card-not-present (CNP)) and the identity of the customer 102. This lack of authentication of the customer 102 and the payment card presents an opportunity for fraud. For example, a person other than the cardholder may obtain the payment card number and expiration date from a discarded payment form and use them to make new purchases.

Payment card fraud cost businesses and consumers nearly three billion dollars in 2001 and is expected to reach eight billion by 2005, if it remains unchecked. In particular, non-face-to-face or card-not-present (CNP) payment transactions represent the fastest growing segment of payment card fraud. CNP transactions include Internet, telephone, mail order, mail order telephone order (MOTO), television, and mobile orders, i.e., prepaid top-up cards, and orders placed with mobile communication devices. The instances of fraud increase when the customer purchases non-physical or “digital” goods, such as an airline e-ticket or mobile phone airtime credits, because there is no shipment of physical goods to trace back to the customer. Most merchant servers 104 utilize some type of heuristic or intelligence data processing algorithms that attempt to analyze transactions with fraud characteristics in order to combat the potential for payment fraud. However, these heuristic systems are designed to determine the propensity of fraud and do not address the fundamental problem of verifying the identity of the cardholder and the presence of the payment card, i.e., authentication of cardholder and payment card.

In the recent years, traditional credit and debit cards that utilize a magnetic stripe to store cardholder information are being replaced by “smart cards” or “chip cards”. Smart cards are plastic cards that have an embedded Integrated Circuit (IC) computer chip. The computer chip stores information including the card number, expiration date, financial institution code, and cardholder information, among others. The computer chip may also include a personal identification number (PIN), a password, and a biometric signal as additional security features. Examples of biometric signals include a retinal scan, a fingerprint, and a portion of a cardholder's DNA, among others. The use of smart cards as payment instruments is becoming widely accepted as a more secure way for consumers to conduct business with merchants because of the embedded security features. Examples of smart cards used for payment include the American Express Blue Card, the Target Smart Visa, and the oneSMART Card from MasterCard International.

Several major payment card associations and financial institutions that include among others Europay, MasterCard, Visa, and American Express have agreed to a payment standard for credit/debit payments that utilizes smart cards, i.e., Europay-MaterCard-Visa (EMV). The worldwide rollout of EMV is contributing to the rapid adoption of smart cards by banks, financial institutions and merchants. The use of smart cards for payment transactions has largely been focused on face-to-face consumer/merchant transactions where consumers use smart cards with merchant Point of Sale (POS) smart card readers. The use of smart cards in connection with merchant POS has the potential of reducing fraud for face-to-face payment transactions. However, CNP transactions will not benefit from EMV and smart cards in the current configuration.

In addition to smart cards with payment capabilities, mobile network operators utilize the strong authentication features of smart cards to authenticate and authorize mobile phones and devices to access their mobile network. The smart cards utilized by mobile network operators are called Subscriber Identity Modules (SIMs). SIMs are significantly smaller than payment smart cards, however, they utilize the same technology as the larger payment smart cards.

There are several patents that employ smart cards and personal computers to transact with Internet and web merchants. U.S. Pat. No. 6,282,522, entitled “Internet Payment System using Smart Card” and U.S. Pat. No. 6,105,008, entitled “Internet Loading System using Smart Card” describe the use of a smart card in connection with a “card reader attached to a personal computer (PC)” for remote payments on “open networks such as the Internet”. Although this solution can greatly reduce fraud for website purchases, it does not address the problem of using the smart card for remote transactions over private networks such as Wireless Wide Area Networks (WWAN) where mobile operators license the network spectrum (i.e. GSM, TDMA, CDMA, iDEN, Mobitex, DataTac), as well as Wireless Local Area Networks (WLAN) (i.e., 802.11a, 802.11b), and Personal Area Networks (PAN) (i.e., Bluetooth, Infrared) that are unlicensed and private to a small group of users. Additionally, the use of a smart card reader that is attached to the PC restricts the customer in using only one PC or carrying the smart card reader and software with the person at all times.

There are also several prior art patents relating to payment schemes using mobile devices over private networks. However, there is still a need for a non-repudiatable payment system for non-face-to-face CNP payment transactions that reduces payment card fraud.

### SUMMARY OF THE INVENTION

In general, in one aspect, the invention features an electronic payment system utilized by a customer to pay for the purchase of a good and/or a service with a payment card. The payment system includes a merchant server, a payment server, an authentication server and a communication device. The merchant server is in connection with a first network, and is adapted to receive a purchase order by the customer for the purchase of the good and/or service and to create a digital order including purchase order information. The payment server is also in connection with the first network, and is adapted to receive the digital order from the merchant server over the first network and to further route the digital order. The authentication server is in connection with the first network, and is adapted to receive the digital order from the payment server over the first network, format the digital order into a first message and route the first message over a second network. The communication device includes identification information of the payment card, and is adapted to receive the first message from the authentication server over the second network, display the first message to the customer, request and receive authorization for payment from the customer, retrieve payment card identification information, request and receive payment card security information from the customer, and route the authorization result and in case of a positive authorization result the payment card identification and security information to the authentication server over the second network. The authorization result and payment card identification and security information are routed from the authentication server to the payment server over the first network and from the payment server to a financial institution over the first network system. The financial institution is the issuer of the payment card and is asked to approve and execute the requested payment and to route the payment approval result through the payment server to the merchant server and to the authentication server.

Implementations of this aspect of the invention may include one or more of the following features. The authentication server may further route the payment approval result to the communication device. The merchant server may be further adapted to receive identification information for the communication device and the authentication server may be adapted to access the communication device via the communication device identification information over the second network. The communication device may further include an authentication client application. The authentication client application includes instructions for receiving the first message from the authentication server over the second network, displaying the first message to the customer, requesting and receiving authorization for payment for the purchase order with the payment card from the customer, retrieving payment card identification number, requesting and receiving payment card security information from the customer, routing the authorization result and in case of a positive authorization result the payment card identification and security information to the authentication server over the second network, and receiving the payment approval result and creating a record. The merchant server upon receiving a positive approval result may fulfill the purchase order. The authentication server may include an authentication server application. The authentication server application includes instructions for receiving the digital order from the payment server over the first network, formatting the digital order into a first message, routing the first message over a second network to the communication device, receiving the authorization result and payment card identification and security information from the communication device, routing the authorization result and payment card identification and security information to the payment server, receiving the payment approval result from the payment server, formatting the payment approval result into a second message and routing the second message to the communication device. The communication device may be a mobile wireless device and the second network may be a wireless network. The mobile wireless device may be a mobile phone, a personal digital assistant, a pager, a wireless laptop computer, a personal computer, a television remote control, or combinations thereof. The second network may be a wireless wide area network (WWAN), a wireless local area network (WLAN) or a wireless personal area network (PAN). The communication device may also be a wired communication device and the second network may be a wired network. The wired communication device may be a telephone or a computer and the wired network may be a telecommunications network or the Internet, respectively. The first network may be the Internet or a telecommunication network. The communication device may include identification information for a plurality of payment cards issued by a plurality of financial institutions. The communication device may include a first Subscriber Identification Module (SIM) card and the first SIM card may be adapted to store communication device and subscriber information. The first SIM card may be adapted to further store the payment card identification information and/or the authentication client application. The communication device may further include a second SIM card, and the second SIM card may be adapted to store the payment card identification information and/or the authentication client application. The communication device may further include an attachment adapted to receive an external payment card and route the external payment card identification information through the communication device to the authentication server. The first or second SIM cards may be Universal Subscriber Identification Module (USIM) cards that can support third-generation (3G) network requirements. The payment card may be a credit card, a debit card, a stored-value card, a coupon card, a reward card, an electronic cash card, loyalty card, or an identification card. The merchant may receive the purchase order via the Internet, telephone connection, mail order form, fax, e-mail, voice recognition system, shot message service, interactive voice recording (IVR), or face-to-face interaction with the customer. The purchase order information may include at least one of price, currency indicator, product identification, product description, quantity, delivery method, delivery date, shipping and billing information, merchant identification, payment method, communication device identification information, and transaction number. The format for the first message may be Short Message Service (SMS), General Packet Radio Service (GPRS), Transmission Control Protocol/Internet Protocol (TCP/IP), User Datagram Protocol (UPD), Simple Mail Transmission Protocol (SMTP), Simple Network Management Protocol (SNMP), or a proprietary message format. The identification information of the payment card may include at least one of payment card number, payment card expiration date, cardholder's name, cardholder's contact information, cardholder's account information, issuer financial institution identification, issuer financial institution contact information, and security information for the authentication of the cardholder. The security information may include at least one of a personal identification number (PIN), password, biometric signal, fingerprint, retinal scan, voice signal, digital signature, and encrypted signature, username and password combinations, identity certificate such as X.509, public and private keys to support Public Key Infrastructure (PKI), a Universal Card Authentication Field (UCAF), or combinations thereof. The security information of the payment card may be entered by the customer via the communication device.

In general, in another aspect, the invention features an electronic payment system utilized by a customer to pay for the purchase of a good and/or a service with a payment card. The payment system includes a merchant server, an authentication server, and a communication device. The merchant server is in connection with a first network, and is adapted to receive a purchase order by the customer for the purchase of the good and/or service and to create a digital order comprising purchase order information. The authentication server is in connection with the first network, and is adapted to receive the digital order from the merchant server over the first network, format the digital order into a first message and route the first message over a second network. The communication device includes identification information of the payment card, and is adapted to receive the first message from the authentication server over the second network, display the first message to the customer, request and receive authorization for payment for the purchase order with the payment card from the customer, retrieve payment card identification information, request and receive payment card security information from the customer, and route the authorization result and in case of a positive authorization result the payment card identification and security information to the authentication server over the second network. The authorization result and payment card identification and security information are routed from the authentication server to the financial institution over the first network system. The financial institution is the issuer of the payment card and is asked to approve and execute the requested payment and to route the payment approval result through the authentication server to the merchant server and to the communication device.

In general, in another aspect, the invention features an electronic payment system utilized by a customer to pay for a purchase of a good and/or a service with a payment card. The payment system includes a merchant server, a financial institution authentication server and a communication device. The merchant server is in connection with a first network, and is adapted to receive a purchase order by the customer for the purchase of the good and/or service and to create a digital order comprising purchase order information. The financial institution authentication server is in connection with the first network, and is adapted to receive the digital order from the merchant server over the first network, format the digital order into a first message and route the first message over a second network. The communication device includes identification information of the payment card, and is adapted to receive the first message from the financial institution authentication server over the second network, display the first message to the customer, request and receive authorization for payment for the purchase order with the payment card from the customer, retrieve payment card identification information, request and receive payment card security information from the customer, and route the authorization result and in case of a positive authorization result the payment card identification and security information to the financial institution authentication server over the second network. The financial institution authentication server is asked to approve and execute the requested payment and to route the approval result to the merchant server and to the communication device.

In general, in another aspect, the invention features a payment authentication system for authenticating the identity of a customer and the presence of a payment card in a non-face-to-face payment transaction for the purchase of a good and/or a service from a merchant server. The payment authentication system includes a payment server, an authentication server, and a communication device. The payment server is in connection with a first network, and is adapted to receive a digital order from the merchant server over the first network and to further route the digital order. The authentication server is in connection with the first network, and is adapted to receive the digital order from the payment server over the first network, format the digital order into a first message and route the first message over a second network. The communication device includes identification information of the payment card, and is adapted to receive the first message from the authentication server over the second network, display the first message to the customer, request and receive authorization for payment for the purchase order with the payment card from the customer, retrieve payment card identification information, request and receive payment card security information from the customer, and route the authorization result and in case of a positive authorization result the payment card identification and security information to the authentication server over the second network. The authorization result and payment card identification and security information are routed from the authentication server to the payment server over the first network and from the payment server to a financial institution over the first network system. The financial institution is the issuer of the payment card and is asked to approve and execute the requested payment and to route the payment approval result through the payment server to the merchant server and to the authentication server.

In general, in another aspect, the invention features a payment authentication system for authenticating the identity of a customer and the presence of a payment card in a non-face-to-face payment transaction for the purchase of a good and/or a service from a merchant server. The payment authentication system includes an authentication server, and a communication device. The authentication server is in connection with a first network, and is adapted to receive a digital order from the merchant server over the first network, format the digital order into a first message and route the first message over a second network. The communication device includes identification information of the payment card, and is adapted to receive the first message from the authentication server over the second network, display the first message to the customer, request and receive authorization for payment for the purchase order with the payment card from the customer, retrieve payment card identification information, request and receive payment card security information from the customer, and route the authorization result and in case of a positive authorization result the payment card identification and security information to the authentication server over the second network. The authorization result and payment card identification and security information are routed from the authentication server to a financial institution over the first network system, wherein the financial institution is the issuer of the payment card and is asked to approve and execute the requested payment and to route the payment approval result through the authentication server to the merchant server and to the communication device.

In general, in yet another aspect, the invention features a payment authentication system for authenticating the identity of a customer and the presence of a payment card in a non-face-to-face payment transaction for the purchase of a good and/or a service from a merchant. The payment authentication system includes an authentication server and a communication device. The authentication server is in connection with a first network, and is adapted to receive a digital order from the merchant server over the first network, format the digital order into a first message and route the first message over a second network. The communication device is adapted to receive the first message from the authentication server over the second network, display the first message to the customer, request and receive authorization for payment for the purchase order with the payment card by the customer, request and receive payment card identification information and security information from the customer, and route the authorization result and in case of a positive authorization result the payment card identification and security information to the authentication server over the second network. The authorization result and payment card identification and security information are routed from the authentication server to a financial institution over the first network system. The financial institution is the issuer of the payment card and is asked to approve and execute the requested payment and to route the payment approval result through the authentication server to the merchant server and to the communication device.

In general, in yet another aspect, the invention features an electronic payment method utilized by a customer for paying with a payment card for the purchase of a good and/or a service. The payment method includes the following. First providing a merchant server that offers a good and/or a service with identification information for a communication device. The communication device includes identification information of the payment card. Next creating a digital order that includes purchase order information and communication device identification number by the merchant server and routing the digital order to an authentication server via a first network. Next, formatting the digital order into a first message that is adapted to be transmitted over a second network, and routing the first message over the second network to the communication device. Next, displaying the first message on the communication device, requesting and receiving authorization of payment from the customer via the communication device, retrieving payment card identification information from the communication device and requesting and receiving payment card security information from the customer via the communication device. Next, routing the authorization result and payment card identification and security information to the authentication server and from the authorization server a financial institution, that is the issuer of the payment card. Finally approving and executing the payment at the financial institution. The method may further include before providing the merchant server with the communication device identification information, placing a purchase order with the merchant server for the good and/or a service, and choosing to pay via the communication device. The method may also include sending notification of the approval and execution of payment to the merchant server and the communication device and fulfilling the purchase order by the merchant server.

Among the advantages of this invention may be one or more of the following. From the customer's viewpoint, the process is similar to that of using a smart card or credit card with a merchant's Point Of Sale (POS) device or a bank's Automated Teller Machine (ATM). The invention has the advantage that the customer is using a personal, trusted mobile communication device to interact remotely with an authentication system and a payment server. The invention may be used for both non-face-to-face and face-to-face transactions. The presence of the payment card and the identity of the cardholder are strongly authenticated. The embedded IC chip in the payment card cannot be easily counterfeited, as is the case with the magnetic strip payment cards. The signature of a cardholder can be easily forged. However, a security feature such as a digital encrypted signature, PIN, password or biometric signal is difficult to copy. The invention offers a CNP payment transaction with a Personal Point of Sale (PPOS™). The combination of a Personal POS with the strong authentication of a smart card offers a dramatic decrease in payment card fraud. It is a convenient method of payment and easy to use for both the customer and the merchant.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is a flow diagram of a prior art system for existing “card-not-present” (CNP) credit/debit card payments.

FIG. 2 is schematic diagram of a payment system according to this invention.

FIG. 2A is a flow diagram of a payment system according to this invention.

FIG. 2B is a flow diagram of another embodiment of the payment system according to this invention.

FIG. 2C is a flow diagram of yet another embodiment of the payment system according to this invention.

FIG. 3 illustrates a prior art mobile phone that utilizes multiple SIM smart cards and an external full-size smart card.

FIG. 4 illustrates a prior art Mobile Device Attachment that converts a Single-SIM GSM phone into a Multi-SIM/Dual-Slot GSM phone.

FIG. 5 illustrates the circuitry for the mobile device attachment of FIG. 4.

FIG. 6 is a diagrammatic view of the system architecture for a mobile payment authorization system according to this invention.

FIG. 7 is a flow diagram of an authentication server application.

FIG. 8 is a flow diagram of an authentication client application.

FIG. 9 is a diagrammatic view of the system architecture for “Single-SIM” mobile payment authorization system.

FIG. 10 is a diagrammatic view of the system architecture for “Multi-SIM” mobile payment authorization system.

FIG. 11 is a diagrammatic view of the system architecture for “Multi-SIM/Dual-Slot” mobile payment authorization system utilizing a mobile device attachment.

FIG. 12 is a diagrammatic view of another embodiment of the system architecture for “Multi-SIM/Dual-Slot” mobile payment authorization system.

FIG. 13 is a flow diagram for a mobile payment authorization and authentication process.

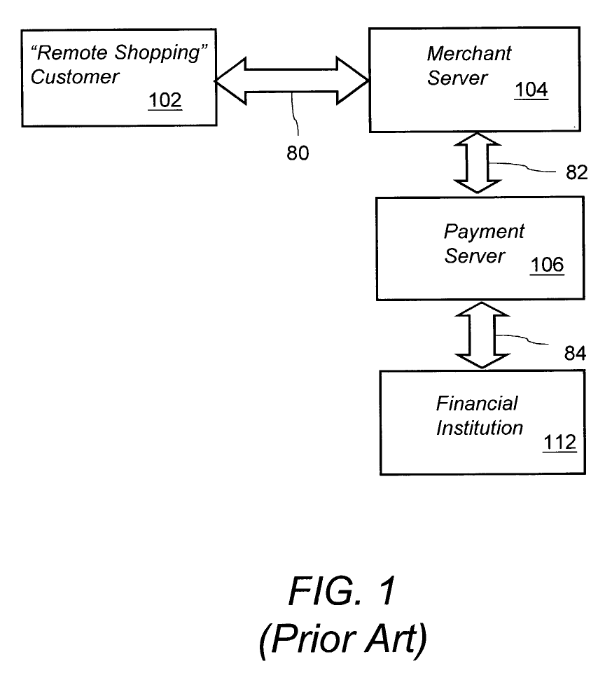

### DETAILED DESCRIPTION OF THE INVENTION

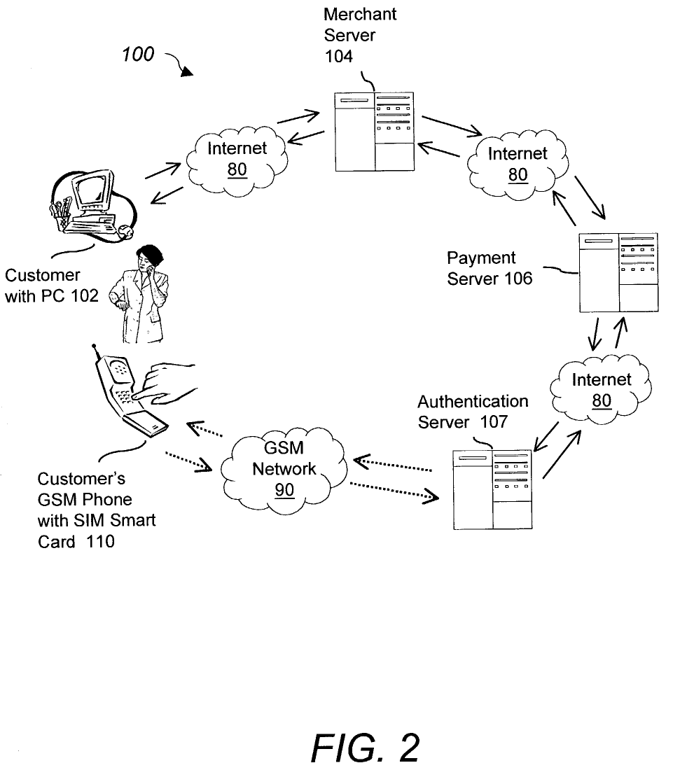

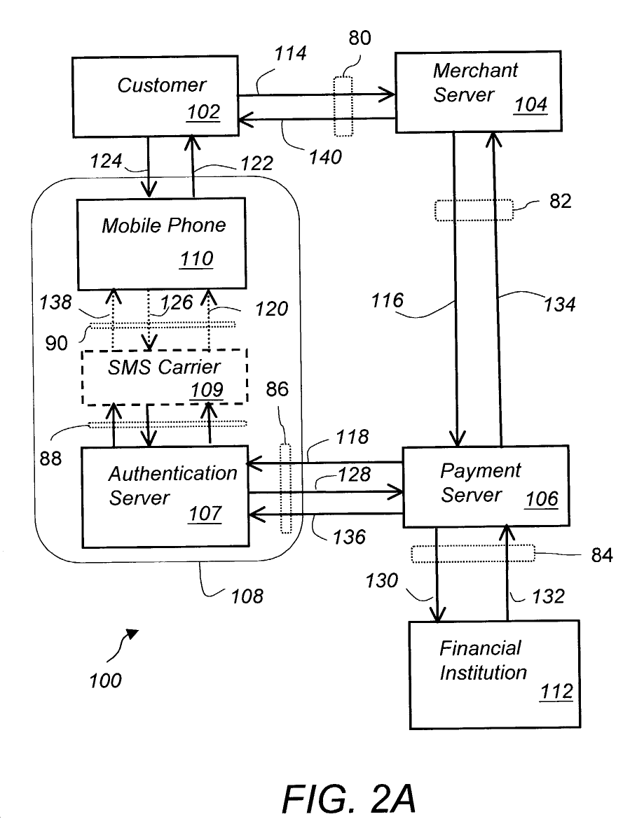

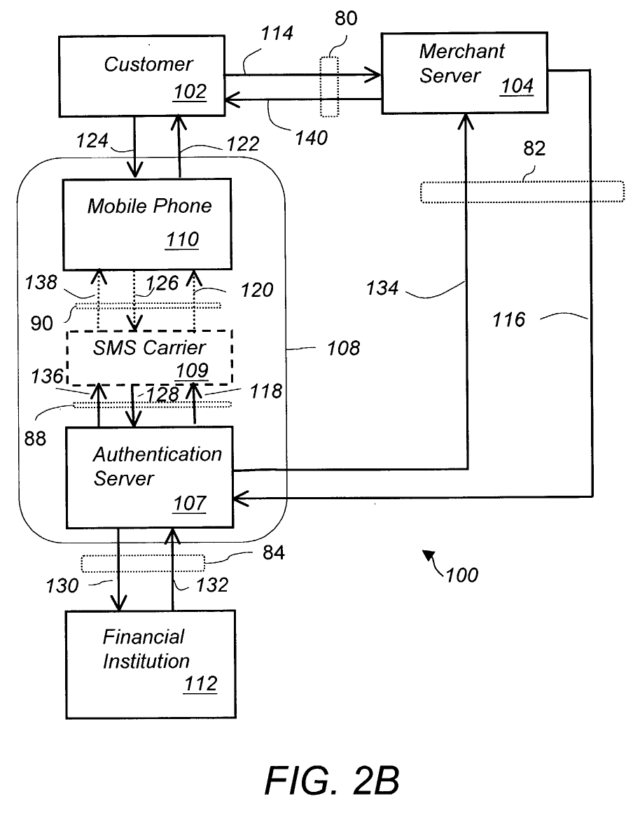

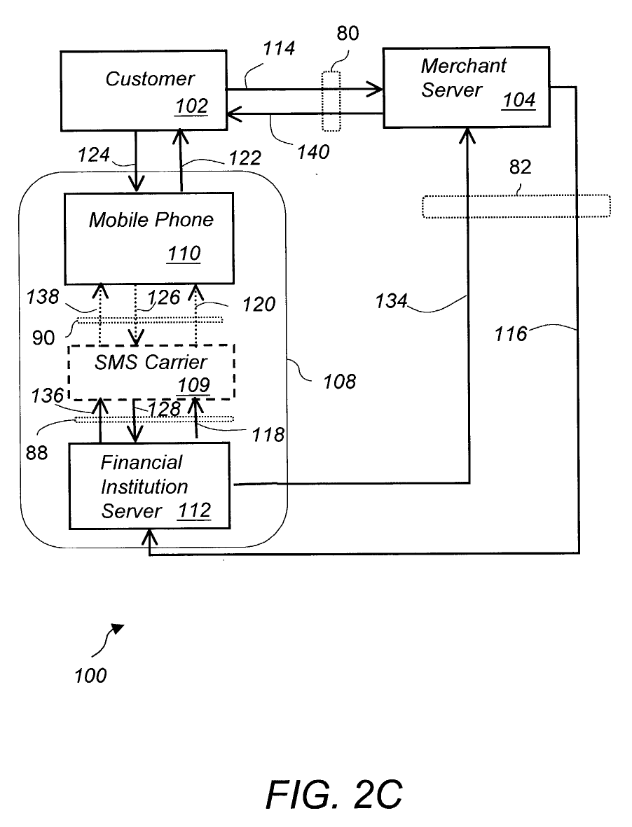

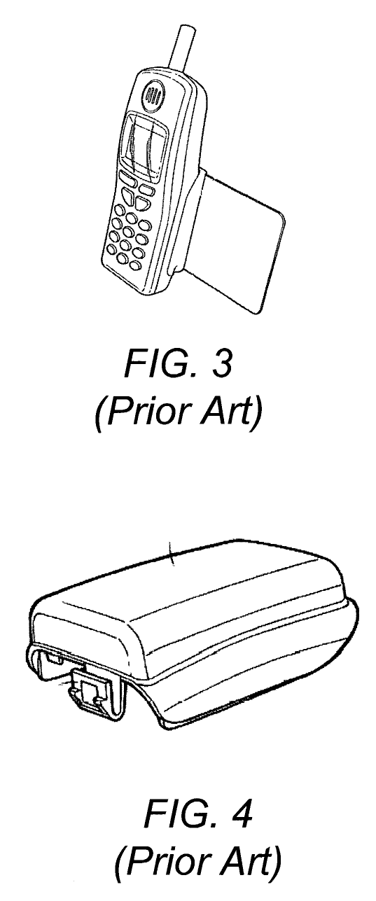

The present invention describes a strong authentication system for non face-to-face payment transactions. The strong authentication system involves smart cards and mobile communication devices. Referring to FIG. 2 and FIG. 2A, a payment transaction system 100 includes a customer 102, a merchant server 104, a payment server 106, an authentication system 108, and a financial institution 112. The authentication system 108 includes an authentication server 107 that is adapted to send and receive messages in a short message service (SMS) format to a mobile phone 110 via an SMS carrier 109. The mobile phone 110 is adapted to receive a payment card (shown in FIG. 3) or has a built-in payment card (not shown). After having placed an order for an item or a service via the Internet 80, a customer 102 is asked to choose a payment method. The customer 102 chooses to pay via her mobile phone 110 and gives her mobile phone identification information to the merchant server 104 (114). In one example, the mobile phone identification information is the mobile phone number. The merchant server 104 routes the customer's mobile phone number and information about the purchase order to a payment server 106 (116). The payment server 106 contacts the authentication server 107 and routes the customer's mobile phone number and information about the purchase (118). The authentication server 107 sends an SMS message to the customer's mobile phone 110 through an SMS carrier 109 (120). The customer 102 receives the SMS message asking her to authorize the purchase and choose a payment card (122). The customer 102 authorizes the purchase, uses a smart card that is associated with his mobile phone 110, and enters a security code to pay and authenticate his purchase (124). In one example, the security code is a personal identification number (PIN). Other examples include a password, digital signature, and a biometric identifier, i.e., retina scan, fingerprint, DNA scan, voice characteristics. The payment card is identified with information that is embedded in the card. In one example the identification information is a payment card number. Other examples of payment card identification include an encrypted transaction signature that can only be decrypted by the financial institution that has issued the payment card, expiration date of the payment card, and a digital signature. The mobile phone 110 sends an SMS message via the SMS Carrier 109 to the authentication server 107. The SMS message includes the authorization result, payment card identification and PIN information (126). The authentication server 107 routes the authorized purchase order and authenticated card to the payment server 106 (128). The payment server 106 contacts the financial institution 112 that has issued the payment card and routes the payment card information and the purchase order information (130). The financial institution 112 processes the payment transaction and sends a confirmation of the payment transaction to the payment server 106 (132). The payment server 106 routes the payment confirmation to the merchant server 104 (134) and to authentication server 107 (136). The authentication server 107 sends an SMS message confirming the payment transaction to the customer's mobile phone 110 (138). Finally the merchant 104 fulfills the customer's purchase order (140).

Merchant server 104 provides the presentation, offering and fulfillment of goods and services, as well as order processing, inventory and accounting functions. In one example, merchant server 104 is an Enterprise Resource Planning (ERP) system provided by companies such as SAP AG, (Neurottstrasse 16, 69190 Walldorf, Germany) or Oracle Corporation (500 Oracle Parkway, Redwood Shores, Calif. 94065). Another example of a merchant server 104 is a travel reservation system such as Saber provided by American Airlines (4333 Amon Carter Boulevard Fort Worth, Tex. 76155). Customer 102 interacts with the merchant server 104 through a “customer interface portal” (not shown). The customer 102 views the offered goods and services and places an order through the customer interface portal. The customer 102 may interacts with the merchant server 104 via online or offline communication networks 80. These communication networks 80 include the Internet, the telephone, mail, and visiting a store. In one example, the customer interface portal is the Amazon.com website that is accessible via the Internet. Other examples of customer interface portals include an order form from a Lands End catalog, that can be filled out, mailed or faxed to the Lands End company, walking into a Wal-Mart store or calling American Airlines on the telephone to make a travel reservation. In the case of the mail order, the purchase order information is entered by a data entry person into the merchant server 104. In the case of a telephone order, the purchase order information is entered by a call center representative into the merchant server 104.

The merchant server 104 processes the payment transaction with the financial institutions 112 that have issued the payment cards, through the payment server 106. The payment server 106 is an application located on a server of a third party company. In one example, the payment server 106 is an application provided by companies including Payment (1601 Elm Street, Suite 900, Dallas, Tex. 75201), QSI Payments Inc. (Level 22, 300 Adelaide Street, Brisbane, Queensland 4000, Australia), and Mosaic Software (Culverdon House Abbots Way, Chertsey, Surrey KT169LE, United Kingdom).

The message routing 114, 140 occurs over communication network 80, message routing 116, 134, occurs over communication network 82, message routing 118, 128, 136 occurs over communication network 86, message routing 120, 122, 124, 126, 138, occurs over communication network 90, and message routing 130, 132, occurs over communication network 84. In one example, communication networks 80, 82, 84, 86, and 88 are the Internet and communication network 90 is a wireless network. The wireless network 90 may be a Wireless Wide Area Network (WWAN) (i.e., GSM, TDMA, CDMA, 3G, iDEN, Mobitex, and DataTac), a Wireless Local Area Network (WLAN) (i.e., 802.11a, 802.11b), or a Personal Area Network (PAN) (i.e., Bluetooth, Infrared). Other examples of communication networks 80, 82, 84, 86, 88 and 90 include private voice and data networks, and public voice and data networks. Message routing 114-140 is encrypted.

In the embodiment of FIG. 2B the operational functions of the payment server are integrated within the authentication server 107. In this embodiment the merchant server 104 routes the purchase order to the authentication server 107 (116). The authentication server 107 also communicates directly with the financial institution 112 (130) after having received authorization of the payment by the customer and authentication of the cardholder's identity and verification of the presence of the payment card (128). Finally the authentication server 107 receives the payment approval by the financial institution 112 (132) and routes the approval to the merchant server 104 (134) and to the mobile phone 110 (136).

In the embodiment of FIG. 2C the operational functions of the payment server and authentication server are integrated within the financial institution server 112. In this embodiment the merchant server 104 routes the purchase order to the financial institution server 112 (116). The financial institution server 112 communicates directly with the mobile phone 110 (118) in order to received authorization of the payment by the customer and authentication of the cardholder's identity and verification of the presence of the payment card. Finally the financial institution server 112 approves and executes the payment transaction and routes the approval to the merchant server 104 (134) and to the mobile phone 110 (136). In this embodiment the merchant purchase order further includes identification information of the financial institution 112.

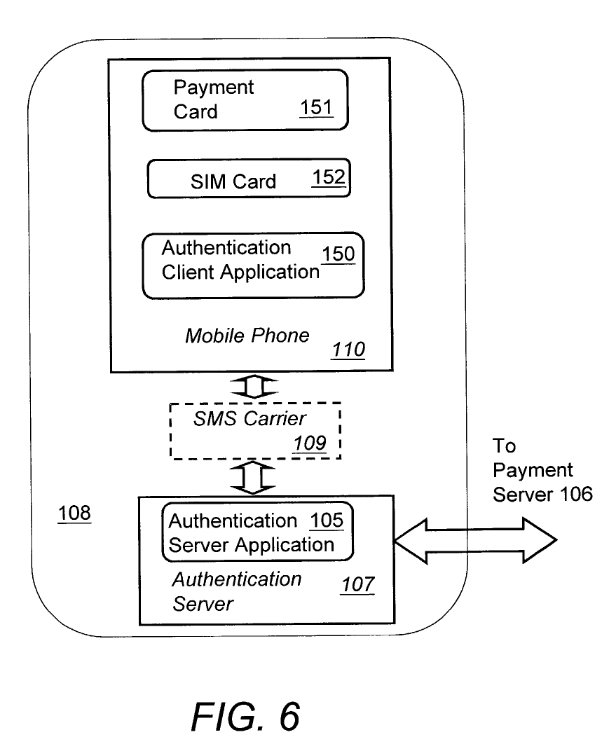

Referring to FIG. 6, the authentication system 108 includes an authentication server 107 that communicates with a mobile phone 110 via an SMS carrier 109. The authentication server 107 includes an authentication server application 105. The mobile phone 110 includes an authentication client application 150, a subscriber identity module (SIM) card 152 and a payment card 151.

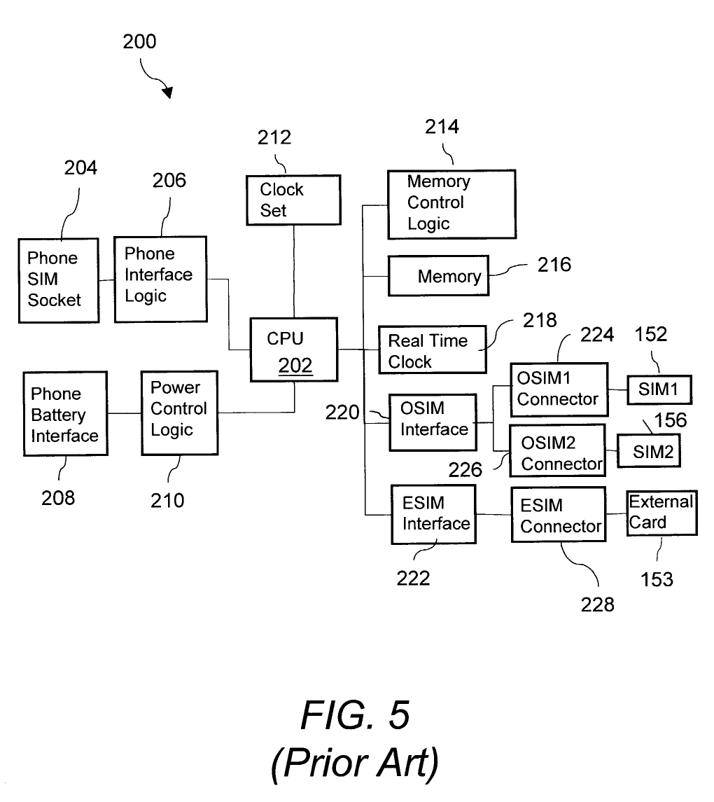

Referring to FIG. 5, in one embodiment, a schematic block diagram of the mobile phone 110 circuitry 200 includes a central processing unit (CPU) 202, which is connected through a phone interface logic arrangement 206 to a phone Subscriber Identification Module (SIM) socket 204. The CPU 202 has a clock arrangement 212 and a power controller logic 210 which connects to a phone battery interface 208. The CPU 202 has a memory 216, a memory control logic 214, and a real time clock 218. The CPU 202 is also connected to original subscriber identification module (OSIM) interface 220, and an external subscriber identification module (ESIM) interface 222. The OSIM interface 220 includes a first OSIM1 connector 224 and a second OSIM2 connector 226. OSIM1 connector 220 connects to a SIM 1 card 152 and OSIM 2 connector connects to SIM 2 card 156. SIM 1 card 152 and SIM 2 card 156 are used to access two different phone network service providers, to store information for two different payment cards and applications. The ESIM interface 222 includes an ESIM connector 228 that connects to an external card reader 153. Circuitry 200 is described in PCT application WO 99/66752 entitled “Communication Method and Apparatus Improvement”, the entire content of which is incorporated herein by reference.

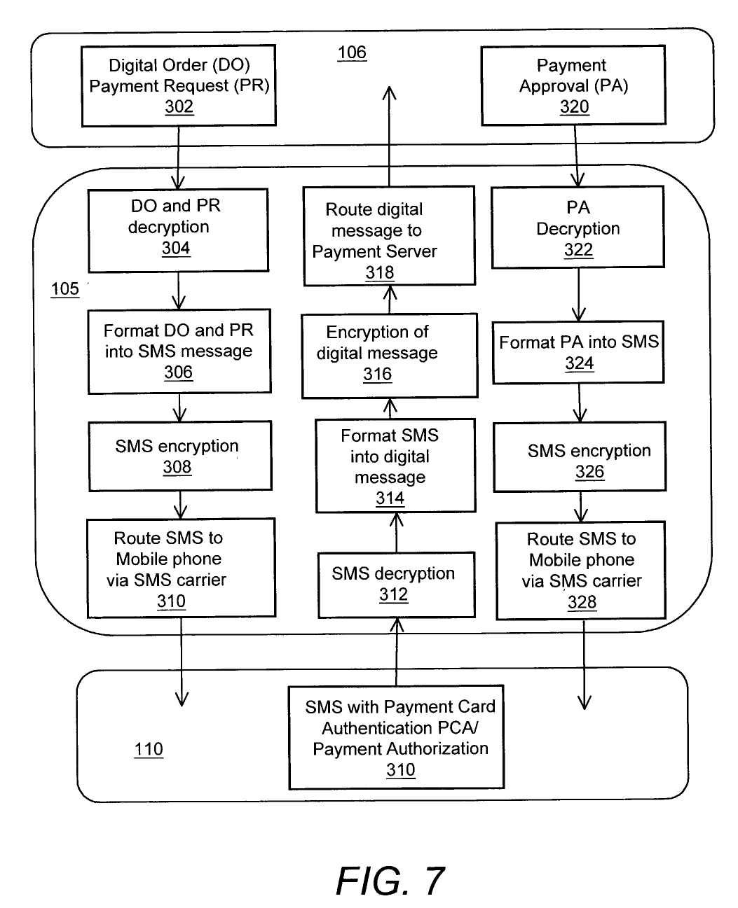

Referring to FIG. 7, the authentication server application 105 receives a digital purchase order and payment request message (302) from the payment server 106, performs message decryption (304), formats the digital order and payment request into an SMS message (306), performs SMS message encryption (308), and performs secure SMS routing to the mobile phone 110 via the SMS carrier 109 (310). The authentication server application 105 also receives an SMS message with payment card authentication and payment authorization (310) from the mobile device 110, performs SMS message decryption (312), formats SMS into a digital message (314), performs digital message encryption (316), and performs secure message routing to the payment server (318). Finally, the authentication server application 105 receives the payment approval message from the payment server (320), performs message decryption (322), formats the payment approval message into an SMS message (324), performs SMS message encryption (326), and performs secure SMS routing to the mobile phone 110 via the SMS carrier 109 (328).

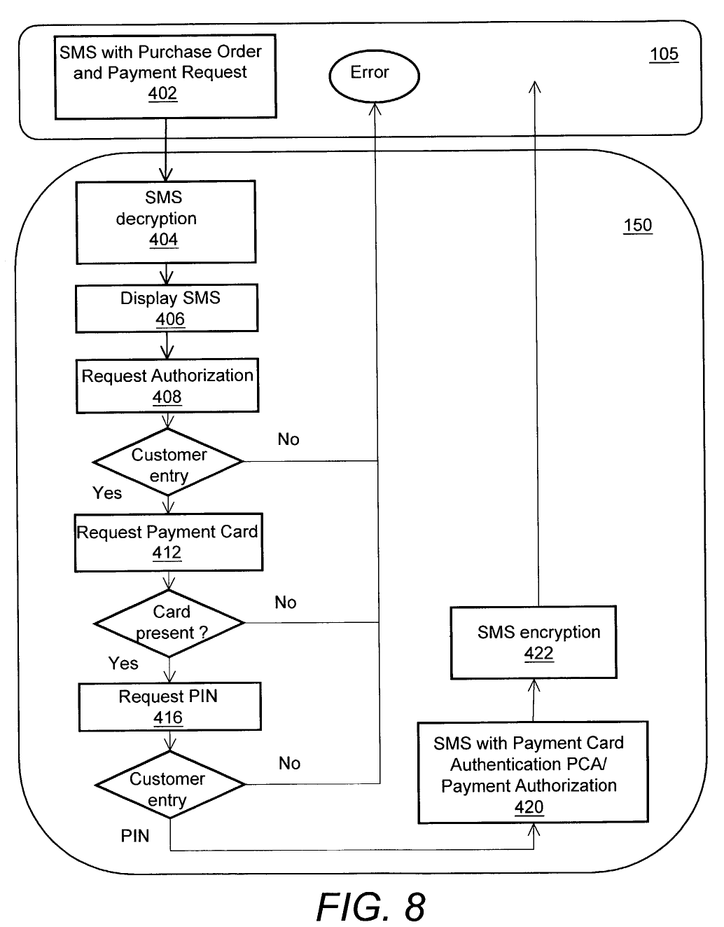

Referring to FIG. 8, the authentication client application 150 receives an SMS message with purchase order information and payment request from the authentication server 107 (402), performs SMS message decryption (404), displays the SMS message in the mobile phone 110 (406), requests authorization from the customer (408), and receives the customer's entry with the authorization result. In the case of a positive authorization, the authentication client application 150 requests the customer to choose a payment card, and retrieves the payment card information (412). If the payment card is present, the authentication client application 150 requests a personal identification number (PIN) (416). The customer enters the personal identification number and the authentication client application 150 composes an SMS message with payment card authentication, i.e., payment card number and PIN, and payment authorization (420), performs message encryption (422) and routes the message to the authentication server 107, where it is received as an input for the authentication server application 105. In the cases when the customer does not authorize payment, payment card is not present, or the PIN number is either not entered or is incorrect, the authentication client application 150 sends an error message to the authentication server 107. The authentication client application 150 further provides a user interface to the mobile phone user, i.e., customer, and manages the interactions between the mobile phone and the payment cards.

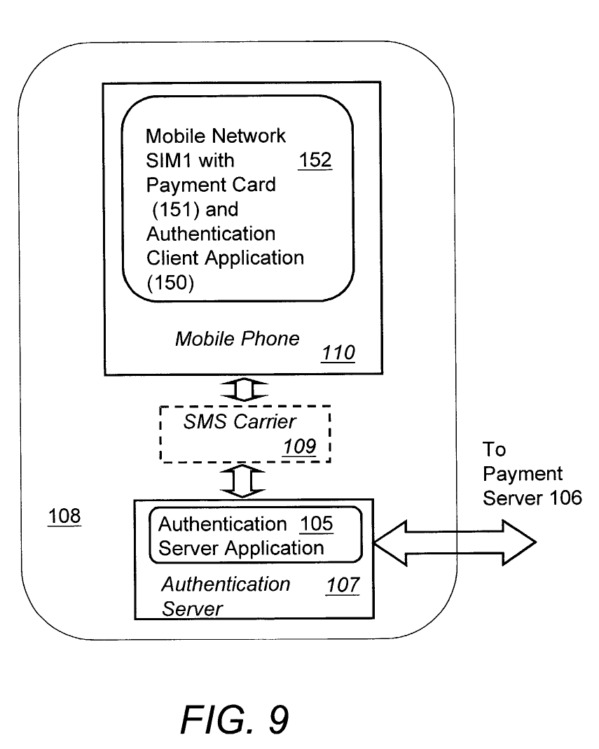

Referring to FIG. 9, in “a single chip” authentication solution, the authentication client application 150 and the payment card 151 are incorporated in a multi-application SIM 1 card 152. The multi-application SIM 1 card 152 is issued by the mobile network operator company 109 in collaboration with the financial institution 112. The mobile network SIM 1 card 152 is an IC circuit that is inserted in a slot in the back of the mobile phone 110 and is programmed by the mobile network operator company that sells the mobile phones and provides the mobile phone network services. In one example, the financial institution 112 (i.e., American Express) and the mobile network company (i.e., Verizon) collaborate to “co-brand” a SIM 1 card that is embedded in the mobile phone 110 (i.e., Amex-Verizon phone).

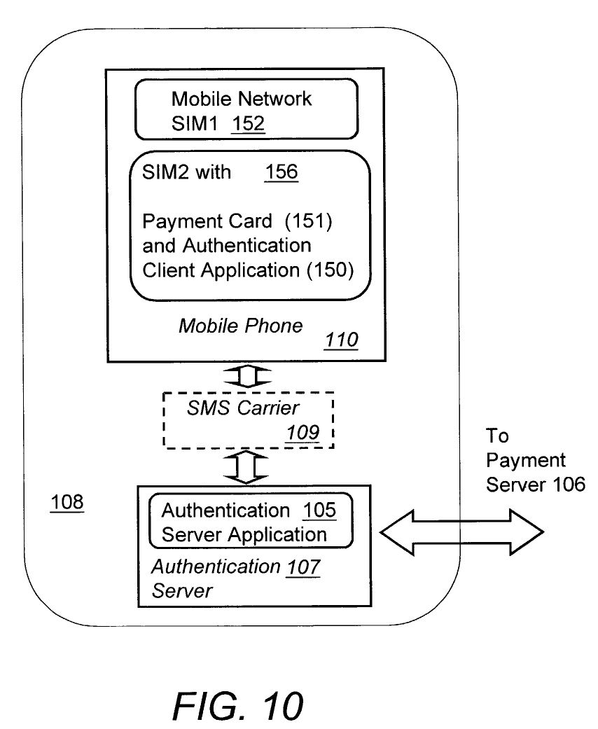

Referring to FIG. 10, in a “dual chip” authentication solution, the authentication client application 150 and the payment card 151 are incorporated in a multi-application SIM 2 card 156. The multi-application SIM 2 card 156 is separate from the mobile network SIM 1 card 152. SIM 1 152 and SIM 2 156 are inserted in slots in the back of the mobile phone 110. SIM 2 may be issued by the financial institution 112 and/or by a second mobile network operator company.

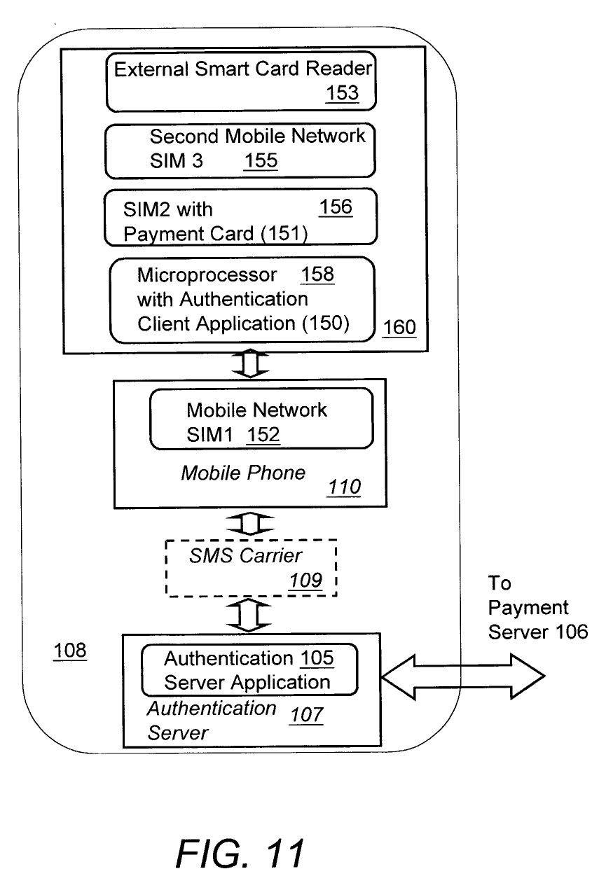

Referring to FIG. 11, in a “multi chip-dual slot” authentication system, the authentication client application 150 and payment card 151 are incorporated in a mobile phone attachment 160. The mobile phone attachment 160 includes a microprocessor 158 that stores the authentication client application 150 and a SIM 2 card 156 that stores the payment card 151. The mobile phone attachment 160 may further include a SIM 3 155 card issued by a secondary mobile network operator company and an external card reader 153. The external card reader 153 receives full size smart payment cards (not shown) issued by a variety of financial institutions. The mobile phone attachment 160 attaches to the back of the mobile phone 110. Mobile phone 110 includes SIM 1 card 152 issued by the original mobile network operator company. This embodiment allows the customer 102 to use two different mobile network operator companies and multiple payment cards. The mobile device attachment 160 is described in the PCT application WO 99/66752 entitled “Communication Method and Apparatus Improvement” the entire content of which is incorporated herein by reference. One example of the mobile device attachment 160 is shown in FIG. 4.

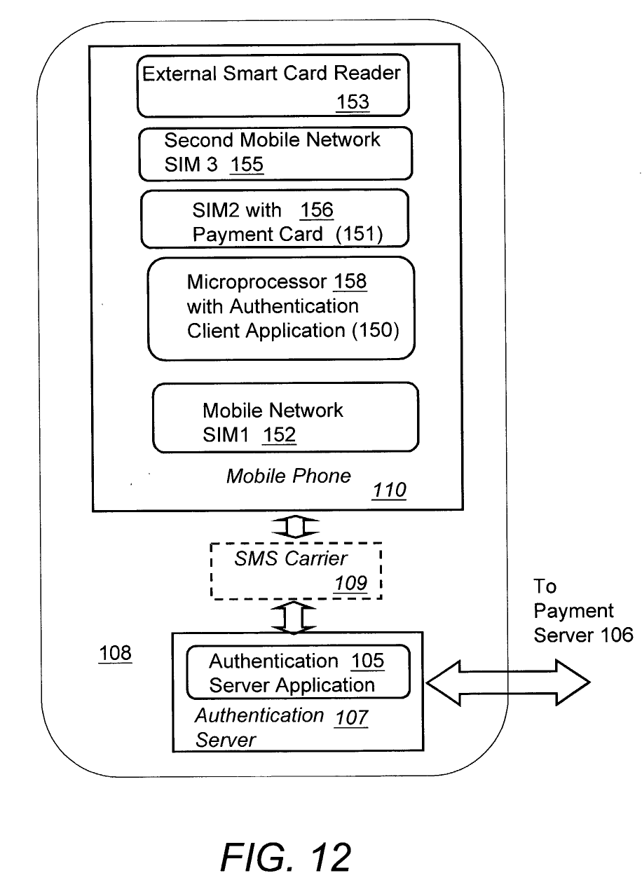

Referring to FIG. 12 the “multi chip-dual slot” authentication system of FIG. 11 is incorporated in the mobile phone 110. The mobile phone 110 includes SIM 1 152 issued by the original mobile network operator company, a microprocessor 158 that stores the authentication client application 150, SIM 2 156 with the payment card 151 information, SIM 3 155 for a second mobile network operator company, and an external card reader 153 that can receive full size payment cards. The “multi chip-dual slot” embodiments of FIG. 11 and FIG. 12 enable a customer to easily switch between multiple bank-issued payment smart cards (i.e. one for American Express, one for Visa, one for Mondex,) and operator-issued mobile network smart cards (i.e. one for VoiceStream, one for mm02 one for Telstra, one for Verizon,). In other embodiments, the authentication system can also reside on an external smart card inserted into the mobile phone's smart card reader 153 producing a “dual slot” authentication system. The external card reader 153 in FIG. 11 and FIG. 12 is adapted to receive a plurality of full-size smart cards for payment issued by a plurality of financial institutions (i.e. American Express, MasterCard, Mondex, VISA).

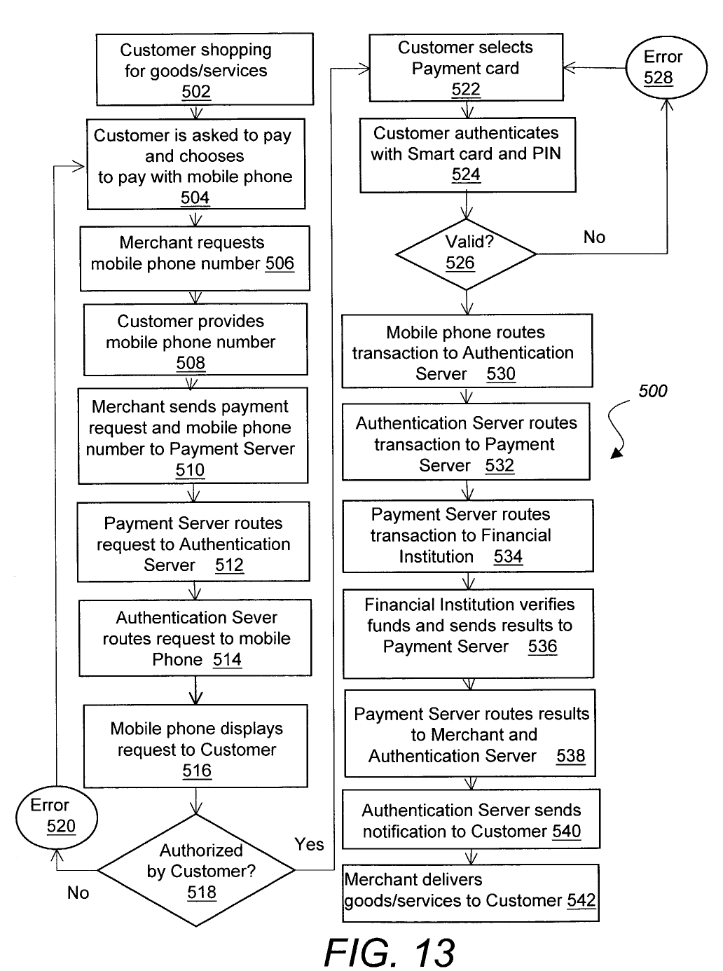

Referring to FIG. 13, an authorization and authentication process for a customer initiated payment transaction 500 includes the following steps. The customer shops for goods and/or services at a merchant site (502). The merchant site may be remote or local and the shopping transaction may be non-face-to face or face-to face, respectively. In one example, a non-face-to face shopping for goods at a remote merchant site is shopping for books at the Amazon.com website through the Internet. In another example, the customer interacts with a sales associate of a merchant site via the phone. In yet another example of a non-face-to-face shopping the customer reads a merchant's catalog and fills out a mail order form. In an example of a face-to-face shopping for a service, the customer is hiring a taxi to drive him from his hotel to the airport. After having placed an order, the customer is asked to choose a payment method for the goods and/or services and he chooses to pay with his mobile phone (504). The merchant request the mobile phone identification information (506). In one example, the mobile phone identification information is the mobile phone number. The customer provides the mobile phone number to the Merchant (508). In one example, the customer types the mobile phone number into a form on the website of the merchant and the information is transmitted to the merchant via the Internet. In another example, the customer interacts with the merchant site via the phone and he enters the mobile phone number using the keypad of the mobile phone or verbally speaking it to the sales associate or to a speech recognition based IVR system. In this example the merchant may also access the mobile phone number via a caller-ID system. The merchant sends a payment request and the mobile phone number to a payment server (510). The payment request includes information about the purchase, i.e., date, time, price, quantity, item code, and delivery date, and information about the identification of the merchant, i.e., store name, store number, and sales associate's name. The payment server routes the payment request and mobile phone number to an authentication server (512). The authentication server sends an SMS message with the payment request via a wireless network to the mobile phone (514). The mobile phone displays the SMS message to the customer (516) and requests authorization for the payment transaction by the customer (518) by selecting “yes” or “no”. If the customer does not authorize the payment transaction, i.e., a “no” selection, an error is displayed on the mobile phone and the customer is asked again to choose a new payment method (520). If the customer authorizes the payment transaction, i.e., a “yes” selection, he is then asked to select a payment card. The customer selects a payment card (522) that is either embedded in the mobile phone or he inserts it in a special slot in the phone. The payment card is a “smart card” i.e., has an embedded IC chip which stores the card number, expiration date, digital signature, information about the financial institution that has issued the card, information about the cardholder and the cardholder's account. In addition to the payment card information, the customer is asked to enter a personal identification number (PIN) to complete the authentication process (524). An authentication client application stored in the mobile phone confirms the validity of the authentication (526). If the authentication is valid the mobile phone routes the payment transaction to the authentication server (530) and the authentication server routes it to the payment server (532). If the authentication is not valid an error is displayed and the customer is asked to select a payment card and repeat the process again (528). The payment server routes the authorized and authenticated payment transaction to the financial institution (534) and the financial institution verifies the availability of funds in the cardholder's account and sends the results to the payment server (536). The payment server routes the results to the merchant server and back to the authentication server (538). The authentication server notifies the customer's mobile phone that the payment transaction has been approved (540) and the merchant delivers the goods and/or services (542). A third party server based authentication method for mobile network operators is described in PCT application WO 00/42792 entitled “Apparatus and method relating to authorization control” the entire content of which is incorporated herein by reference.

Other embodiments are within the scope of the following claims. For example, the mobile phone identification information may be an Internet Protocol (IP) address. The communication networks 80, 82, 84, 86, 88 and 90 may be wireless or wired networks. The communication networks 80, 82, 84, 86, 88 and 90 may be non face-to-face via the Internet, VPN (Virtual Private Network), cable network, data network, telephone network, private voice and data networks, public voice and data networks, and mail or person to person. Payment card identification may occur via the payment card number or via an encrypted transaction signature that can only be decrypted by the financial institution that has issued the payment card. The authentication client application 150 may also utilize a password, digital signature, or a biometric identifier, i.e., retina scan, fingerprint, voice characteristics, to authenticate the payment transaction. The payment authentication instrument may be contained on SIM smart cards within the mobile phone 110, or within full-size smart cards inserted into a smart card reader 153 that is either attached to or embedded in the Mobile Device 110. The communication between the authentication server 107 and the mobile phone 110 may be via a proprietary message protocol that utilizes User Datagram Protocol (UDP) on top of Internet Protocol (IP). This proprietary message protocol is adapted to be used with wireless networks that support Transmission Control Protocol/Internet Protocol (TCP/IP). These wireless networks include Bluetooth, 3G, GPRS, 2.5G, Infrared, 802.11a and 802.11b.

Several embodiments of the present invention have been described. Nevertheless, it will be understood that various modifications may be made without departing from the spirit and scope of the invention. Accordingly, other embodiments are within the scope of the following claims.

What is claimed is:

1. An electronic payment system utilized by a customer to pay for a purchase of a good and/or a service with a payment card wherein said payment card is issued by a financial institution comprising:
a merchant server in connection with a first network, wherein said merchant server is adapted to receive a purchase order by said customer for the purchase of said good and/ or service and to create a digital order comprising purchase order information;
a payment server in connection with said first network, wherein said payment server is adapted to receive said digital order from said merchant server over said first network and to further route said digital order;
an authentication server in connection with said first network, wherein said authentication server is adapted to receive said digital order from said payment server over said first network, format said digital order into a first message and route said first message over a second network;
a communication device comprising identification information of said payment card, wherein said communication device is adapted to receive said first message from said authentication server over said second network, display said first message to said customer, request and receive authorization for payment for said purchase order with said payment card from said customer, retrieve payment card identification information, request and receive payment card security information from said customer, and route the authorization result and in case of a positive authorization result the payment card identification and security information to the authentication server over said second network; and
wherein said authorization result and payment card identification and security information are routed from said authentication server to said payment server over said first network and from said payment server to said financial institution over said first network system, wherein said financial institution is asked to approve and execute the requested payment and to route the payment approval result through said payment server to said merchant server and to said authentication server.

2. The electronic payment system of claim 1 wherein said authentication server further routes the payment approval result to said communication device.

3. The electronic payment system of claim 1 wherein said merchant server is further adapted to receive identification information for said communication device.

4. The electronic payment system of claim 3 wherein said authentication server is adapted to access said communication device via said communication device identification information and over said second network.

5. The electronic payment system of claim 2 wherein said communication device further comprises an authentication client application wherein said authentication client application comprises instructions for receiving said first message from said authentication server over said second network, displaying said first message to said customer, requesting and receiving authorization for payment for said purchase order with said payment card from said customer, retrieving payment card identification information, requesting and receiving payment card security information from said customer, routing the authorization result and in case of a positive authorization result the payment card identification and security information to the authentication server over said second network, and receiving said payment approval result and creating a record.

6. The electronic payment system of claim 1 wherein said merchant server upon receiving a positive approval result fulfills said purchase order.

7. The electronic payment system of claim 1 wherein said authentication server comprises an authentication server application and wherein said authentication server application comprises instructions for receiving said digital order from said payment server over said first network, formatting said digital order into a first message, routing said first message over a second network to said communication device, receiving said authorization result and payment card identification and security information from said communication device, routing said authorization result and payment card identification and security information to said payment server, receiving said payment approval result from said payment server, formatting said payment approval result into a second message and routing said second message to said communication device.

8. The electronic payment system of claim 1 wherein said communication device comprises a mobile wireless device and said second network comprises a wireless network.

9. The electronic payment system of claim 8 wherein said mobile wireless device is selected from a group consisting of a mobile phone, a personal digital assistant, a pager, wireless laptop computer, personal computer, television remote control, and combinations thereof.

10. The electronic payment system of claim 8 wherein said second network comprises a private communication network.

11. The electronic payment system of claim 8 wherein said second network is selected from a group consisting of a wireless wide area network (WWAN), a wireless local area network (WLAN), and a personal area network (PAN).

12. The electronic payment system of claim 1 wherein said communication device comprises a wired communication device and said second network comprises a wired network.

13. The electronic payment system of claim 12 wherein said wired communication device comprises a telephone and said wired network comprises a telecommunications network.

14. The electronic payment system of claim 12 wherein said wired communication device comprises a computer and said wired network comprises the Internet.

15. The electronic payment system of claim 1 wherein said first network comprises the Internet.

16. The electronic payment system of claim 1 wherein said first network comprises a telecommunication network.

17. The electronic payment system of claim 1 wherein said communication device comprises identification information for a plurality of payment cards issued by a plurality of financial institutions .

18. The electronic payment system of claim 1 wherein said communication device comprises a first Subscriber Identification Module (SIM) card wherein said first SIM card is adapted to store communication device and subscriber information.

19. The electronic payment system of claim 18 wherein said first SIM card is adapted to further store said payment card identification information.

20. The electronic payment system of claim 19 wherein said communication device further comprises an authentication client application and said first SIM card is adapted to further store said authentication client application.

21. The electronic payment system of claim 18 wherein said communication device further comprises a second SIM card, wherein said second SIM card is adapted to store said payment card identification information.

22. The electronic payment system of claim 21 wherein said communication device further comprises an authentication client application and said second SIM card is adapted to further store said authentication client application.

23. The electronic payment system of claim 19 wherein said communication device further comprises an attachment adapted to receive an external payment card and route said external payment card identification information through said communication device to said authentication server.

24. The electronic payment system of claim 21 wherein said communication device further comprises an attachment adapted to receive an external payment card and route said external payment card identification information through said communication device to said authentication server.

25. The electronic payment system of claim 1 wherein said communication device further comprises an attachment adapted to receive said payment card and route said payment card identification information through said communication device to said authentication server.

26. The electronic payment system of claim 21 wherein any of said SIM cards comprises a Universal Subscriber Identification Module (USIM), and wherein said USIM is adapted to support third-generation (3G) network requirements.

27. The electronic payment system of claim 1 wherein said payment card is selected from a group consisting of a credit card, debit card, a stored-value card, a coupon card, a reward card, an electronic cash card, loyalty card, and an identification card.

28. The electronic payment system of claim 1 wherein said merchant receives said purchase order via a route selected from a group consisting of the Internet, telephone connection, mail order form, fax, e-mail, voice recognition system, shot message service, interactive voice recording (IVR), and face-to-face interaction with the customer.

29. The electronic payment system of claim 1 wherein said purchase order information comprises at least one of price, currency indicator, product identification, product description, quantity, delivery method, delivery date, shipping and billing information, merchant identification, payment method, communication device identification information, and transaction number.

30. The electronic payment system of claim 1 wherein said first message comprises a format selected from a group consisting of Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), and proprietary message formats.

31. The electronic payment system of claim 1 wherein said identification information of said payment card comprises at least one of payment card number, payment card expiration date, cardholder's name, cardholder's contact information, cardholder's account information, issuer financial institution identification, issuer financial institution contact information, and security information.

32. The electronic payment system of claim 1 wherein said security information of said payment card comprises at least one of a personal identification number (PIN), password, biometric signal, fingerprint, retinal scan, voice signal, digital signature, encrypted signature, username and password combination, identity certificate, public and private keys supporting Public Key Infrastructure (PKI), Universal Card Authentication Field (UCAF™) and combinations thereof.

33. An electronic payment system utilized by a customer to pay for a purchase of a good and/or a service with a payment card wherein said payment card is issued by a financial institution comprising:
a merchant server in connection with a first network, wherein said merchant server is adapted to receive a purchase order by said customer for the purchase of said good and/ or service and to create a digital order comprising purchase order information;
an authentication server in connection with said first network, wherein said authentication server is adapted to receive said digital order from said merchant server over said first network, format said digital order into a first message and route said first message over a second network;
a communication device comprising identification information of said payment card, wherein said communication device is adapted to receive said first message from said authentication server over said second network, display said first message to said customer, request and receive authorization for payment for said purchase order with said payment card from said customer, retrieve payment card identification information, request and receive payment card security information from said customer, and route the authorization result and in case of a positive authorization result the payment card identification and security information to the authentication server over said second network; and
wherein said authorization result and payment card identification and security information are routed from said authentication server to said financial institution over said first network system, wherein said financial institution is asked to approve and execute the requested payment and to route the payment approval result through said authentication server to said merchant server and to said communication device.

34. An electronic payment system utilized by a customer to pay for a purchase of a good and/or a service with a payment card issued by a financial institution comprising:
a merchant server in connection with a first network, wherein said merchant server is adapted to receive a purchase order by said customer for the purchase of said good and/or service and to create a digital order comprising purchase order information;
a financial institution authentication server in connection with said first network, wherein said financial institution authentication server is adapted to receive said digital order from said merchant server over said first network, format said digital order into a first message and route said first message over a second network;
a communication device comprising identification information of said payment card, wherein said communication device is adapted to receive said first message from said financial institution authentication server over said second network, display said first message to said customer, request and receive authorization for payment for said purchase order with said payment card from said customer, retrieve payment card identification information, request and receive payment card security information from said customer, and route the authorization result and in case of a positive authorization result the payment card identification and security information to the financial institution authentication server over said second network; and
wherein said financial institution authentication server is asked to approve and execute the requested payment and to route the approval result to said merchant server and to said communication device.

35. A payment authentication system for authenticating the identity of a customer and the presence of a payment card in a non-face-to-face payment transaction wherein said customer purchases a good and/or a service from a merchant server comprising:
a payment server in connection with said a first network, wherein said payment server is adapted to receive a digital order from said merchant server over said first network and to further route said digital order;
an authentication server in connection with said first network, wherein said authentication server is adapted to receive said digital order from said payment server over said first network, format said digital order into a first message and route said first message over a second network;
a communication device comprising identification information of said payment card, wherein said communication device is adapted to receive said first message from said authentication server over said second network, display said first message to said customer, request and receive authorization for payment for said purchase order with said payment card from said customer, retrieve payment card identification information, request and receive payment card security information from said customer, and route the authorization result and in case of a positive authorization result the payment card identification and security information to the authentication server over said second network; and
wherein said authorization result and payment card identification and security information are routed from said authentication server to said payment server over said first network and from said payment server to a financial institution over said first network system, wherein said financial institution is the issuer of said payment card and is asked to approve and execute the requested payment and to route the payment approval result through said payment server to said merchant server and to said authentication server.

36. A payment authentication system for authenticating the identity of a customer and the presence of a payment card in a non-face-to-face payment transaction wherein said customer purchases a good and/or a service from a merchant server comprising:
an authentication server in connection with a first network, wherein said authentication server is adapted to receive a digital order from said merchant server over said first network, format said digital order into a first message and route said first message over a second network;
a communication device comprising identification information of said payment card, wherein said communication device is adapted to receive said first message from said authentication server over said second network, display said first message to said customer, request and receive authorization for payment for said purchase order with said payment card from said customer, retrieve payment card identification information, request and receive payment card security information from said customer, and route the authorization result and in case of a positive authorization result the payment card identification and security information to the authentication server over said second network; and
wherein said authorization result and payment card identification and security information are routed from said authentication server to a financial institution over said first network system, wherein said financial institution is the issuer of said payment card and is asked to approve and execute the requested payment and to route the payment approval result through said authentication server to said merchant server and to said communication device.

37. A payment authentication system for authenticating the identity of a customer and the presence of a payment card in a non-face-to-face payment transaction wherein said customer purchases a good and/or a service from a merchant server comprising:
an authentication server in connection with a first network, wherein said authentication server is adapted to receive a digital order from said merchant server over said first network, format said digital order into a first message and route said first message over a second network;
a communication device wherein said communication device is adapted to receive said first message from said authentication server over said second network, display said first message to said customer, request and receive authorization for payment for said purchase order with said payment card by said customer, request and receive payment card identification information and security information from said customer, and route the authorization result and in case of a positive authorization result the payment card identification and security information to the authentication server over said second network; and
wherein said authorization result and payment card identification and security information are routed from said authentication server to a financial institution over said first network system, wherein said financial institution is the issuer of said payment card and is asked to approve and execute the requested payment and to route the payment approval result through said authentication server to said merchant server and to said communication device.

38. An electronic payment method utilized by a customer for payment with a payment card for a purchase of a good and/or a service said payment method comprising:
providing a merchant server with identification information for a communication device wherein said merchant server offers said good and/or service and said communication device comprises identification information of said payment card;
creating a digital order comprising purchase order information and said identification number for said communication device by said merchant server;
routing said digital order to an authentication server via a first network;
formatting said digital order into a first message wherein said first message is adapted to be transmitted over a second network;
routing said first message over said second network to said communication device;
displaying said first message on said communication device;
requesting and receiving authorization of payment from the customer via said communication device;
retrieving payment card identification information from said communication device;
requesting and receiving payment card security information from said customer via said communication device;
routing authorization result and payment card identification and security information to said authentication server;
routing said authorization result and payment card identification and security information to a financial institution, wherein said financial institution is the issuer of said payment card; and
approving and executing said payment at said financial institution.

39. The electronic payment method of claim 38 further comprising:
before providing said merchant server with said identification information for said communication device;
placing a purchase order with said merchant server for said good and/or service; and
choosing to pay via said communication device.

40. The electronic payment method of claim 38 further comprising:
sending notification of said approval and execution of payment to said merchant server and said communication device.

41. The electronic payment method of claim 40 further comprising:
fulfilling said purchase order by said merchant server.

42. The electronic payment method of claim 38 wherein said communication device comprises a mobile wireless device and said second network comprises a wireless network.

43. The electronic payment method of claim 38 wherein said mobile wireless device is selected from a group consisting of a mobile phone, a personal digital assistant, a pager, a wireless laptop computer, a personal computer, a television remote control, and combinations thereof.

44. The electronic payment method of claim 38 wherein said second network is selected from a group consisting of a wireless wide area network (WWAN), a wireless local area network (WLAN), and a personal area network (PAN).

45. The electronic payment method of claim 38 wherein said communication device comprises a wired device and said second network comprises a wired network.

46. The electronic payment method of claim 45 wherein said wired communication device comprises a telephone and said wired network comprises a telecommunications network.

47. The electronic payment method of claim 45 wherein said wired communication device comprises a computer and said wired network comprises the Internet.

48. The electronic payment method of claim 38 wherein said first network comprises the Internet.

49. The electronic payment method of claim 38 wherein said first network comprises a telecommunication network.

50. The electronic payment method of claim 38 wherein said communication device comprises identification information for a plurality of payment cards issued by a plurality of financial institutions.

51. The electronic payment method of claim 38 wherein said communication device comprises a first Subscriber Identification Module (SIM) card wherein said first SIM card is adapted to store communication device and subscriber information for the second network.

52. The electronic payment method of claim 51 wherein said first SIM card is adapted to further store said identification information for said payment card.

53. The electronic payment method of claim 52 wherein said communication device further comprises an authentication client application and said first SIM card is adapted to further store said authentication client application.

54. The electronic payment method of claim 51 wherein said communication device further comprises a second SIM card, wherein said second SIM card is adapted to store said identification information for said payment card.

55. The electronic payment method of claim 54 wherein said communication device further comprises an authentication client application and said second SIM card is adapted to further store said authentication client application.

56. The electronic payment method of claim 52 wherein said communication device further comprises an attachment adapted to receive an external payment card and route said external payment card identification information through said communication device to said authentication server.

57. The electronic payment method of claim 54 wherein said communication device further comprises an attachment adapted to receive an external payment card and route said external payment card identification information through said communication device to said authentication server.

58. The electronic payment method of claim 38 wherein said communication device further comprises an attachment adapted to receive said payment card and route said payment card identification information through said communication device to said authentication server.

59. The electronic payment method of claim 54 wherein any of said SIM cards comprises a Universal Subscriber Identification Module (USIM), and wherein said USIM is adapted to support third-generation (3G) network requirements.

60. The electronic payment method of claim 38 wherein said payment card is selected from a group consisting of a credit card, debit card, a stored-value card, a coupon card, a reward card, an electronic cash card, loyalty card, and an identification card.

61. The electronic payment method of claim 38 wherein said merchant receives said purchase order via a route selected from a group consisting of the Internet, telephone connection, mail order form, fax, e-mail, voice recognition system, short message service SMS), interactive voice recording (IVR), and face-to-face interaction with the customer.

62. The electronic payment method of claim 38 wherein said purchase order information comprises at least one of price, currency indicator, product identification, product description, quantity, delivery method, delivery date, shipping and billing information, merchant identification, payment method, communication device identification information, and transaction number.

63. The electronic payment method of claim 38 wherein said first message comprises a format selected from a group consisting of Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), and proprietary message formats

64. The electronic payment method of claim 38 wherein said identification information of said payment card comprises at least one of payment card number, payment card expiration date, cardholder's name, cardholder's contact information, cardholder's account information, issuer financial institution identification, issuer financial institution contact information, and security information

65. The electronic payment method of claim 38 wherein said security information of said payment card comprises at least one of a personal identification number (PIN), password, biometric signal, fingerprint, retinal scan, voice signal, digital signature, encrypted signature, username and password combination, identity certificate, public and private keys supporting Public Key Infrastructure (PKI), Universal Card Authentication Field (UCAF™) and combinations thereof.

66. An electronic method of transacting a sale of a good and/or service by a merchant server comprising:
receiving a purchase order for said good and/or service;
receiving a request to pay via a communication device, wherein said communication device comprises identification information of a payment card;
receiving identification information for said communication device;
creating a digital order comprising purchase order information and communication device identification information;
routing said digital order to an authentication server via a first network;
formatting said digital order into a first message wherein said first message is adapted to be transmitted over a second network;
routing said first message over said second network to said communication device;
displaying said first message on said communication device;
requesting and receiving authorization of payment from a customer via said communication device;
retrieving payment card identification information from said communication device;
requesting and receiving payment card security information from said customer via said communication device;
routing authorization result and payment card identification and security information to said authentication server;
routing said authorization result and payment card identification and security information to a financial institution, wherein said financial institution is the issuer of said payment card;
approving and executing said payment at said financial institution;
receiving notification of said approval and execution of payment; and
fulfilling said purchase order by said merchant server.
